(19) United States
(12) Patent Application Publication
(10) Pub. No.: US 2016/0381025 A1
(43) Pub. Date: Dec. 29, 2016

(54) AD HOC END-TO-END AUTHENTICATION AND AUTHORIZATION OF LOGISTICS NETWORK SERVICES

(71) Applicant: SAP SE, Walldorf (DE)

(72) Inventors: Theodor Foerster, Mannheim (DE); Ivo Schmidt, Wuppertal (DE); Sergey Smirnov, Heidelberg (DE); Petra Hochstein, Duesseldorf (DE)

(21) Appl. No.: 14/754,578

(22) Filed: Jun. 29, 2015

(51) Int. Cl. H04L 29/06; G06Q 10/08

(52) U.S. Cl. CPC H04L 63/10; G06Q 10/083

(57) ABSTRACT

Using a mobile solution as described, external logistics providers can be readily on-boarded into a logistics network and identified as trusted providers at a customer or other transport participant site. For example, an electronic authentication token can be provided to a first mobile device of an external logistics provider operator to authorize the external logistics provider operator for a specific transport assignment. When a request for verification is received from an other transport participant in the transport assignment a server can verify that the external logistics provider operator is registered and authenticated for the transport assignment, and notify the other transport participant via a confirmation message to a second mobile device used by the transport participant.

### TECHNICAL FIELD

The subject matter described herein relates to authentication and authorization of logistics network services.

### BACKGROUND

Logistics networks, which can also be referred to as supply chains, delivery networks, or the like, are generally designed to handle service peaks by distributing required workloads through the members of a network of logistics providers (e.g. transportation or storage services, raw materials sources, or the like). Various aspects of “just in time” production as well as recent increases in Internet commerce have resulted in increasing demand for transportation and delivery of packages, parcels, and other shipments requiring transportation resources of a logistics network. In some cases, transportation providers can more efficiently handle peak demand by outsourcing certain transportation runs. However, outsourcing of such tasks can be complicated by requirements for establishing trust between different participants in a logistics network (e.g. for business to business interactions) and between participants and customers (e.g. for business to customer interactions).

### SUMMARY

In one aspect, a method includes providing an electronic authentication token from a server implemented on one or more computing machines to a first mobile device of an external logistics provider operator. The electronic authentication token authorizes the external logistics provider operator for a transport assignment. When a request for verification is received from an other transport participant in the transport assignment, the sever verifies that the external logistics provider operator is registered and authenticated for the transport assignment. The request for verification can include receipt at the server from a second mobile device of the other transport participant of the electronic authentication token that has been exchanged from the first mobile device to the second mobile device. The server then provides a notification, via a confirmation message to the second mobile device, that the external logistics provider operator is authenticated for the transport assignment.

In some variations one or more of the following features can optionally be included in any feasible combination. The method can further include receiving a registration request for the external logistics provider operator at the server (e.g. form the first mobile device) and authenticating the external logistics provider operator at the server. The electronic authentication token can include one or more of a quick response code, a bar code, and a near field communications code. The request for verification can be received from the other transport participant in the transport assignment after the second mobile device captures the electronic authentication token displayed on the first mobile device. The electronic authorization token can be logically linked to the transport assignment and only valid for a duration of the transport assignment. The method can further include providing a second electronic authentication token from the server to the first mobile device of the external logistics provider operator. The second electronic authentication token authorizes the external logistics provider operator for a second transport assignment.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating features of a logistics network;

FIG. 2 shows a diagram illustrating a logical view of a computing architecture that can be used consistent with implementations of the current subject matter;

FIG. 3 shows a diagram illustrating a technical view of a computing architecture that can be used consistent with implementations of the current subject matter;

FIG. 4A shows a user interface screen view illustrating login features to allow a driver or external logistics company manager to authenticate to a trusted logistics network to collect and submit data;

FIG. 4B shows a user interface screen view illustrating features for inserting data about an external logistics provider driver;

FIG. 4C shows a user interface screen view illustrating features for inserting data about an external logistics provider vehicle;

FIG. 5 shows a user interface screen view illustrating features for a trusted logistics network manager to review and approve registration data for ELPs;

FIGS. 6A and 6B show user interface screen views illustrating features for receiving and reviewing token for authenticating an ELP for a transport assignment;

FIGS. 7A, 7B, and 7C show user interface screen views illustrating features via which a transport assignment originator or recipient verifies an authorization token of the ELPf or the transport assignment; and

FIG. 8 shows a process flow diagram illustrating aspects of a method having one or more features consistent with implementations of the current subject matter;

When practical, similar reference numbers denote similar structures, features, or elements.

### DETAILED DESCRIPTION

It can be necessary to quickly expand a logistics network in certain situations (for example due to equipment failure, unexpected transportation demands, etc.) and to do so by outsourcing at least some of the logistics workload to external logistics providers. These external logistics providers may also be requested to handle business to business (B2B) parcel exchanges, which need to be handled by trusted entities. Establishing trust towards external logistics providers is extremely important and is of a key value for all business customers, as parcels can be of high value, can contain confidential content, and can require handling with professional care. The term “parcel” is used herein to refer to any kind of physical cargo that might be handled by a logistics network, including but not limited to documents, materials, products, cargo, or the like.

The term “external” in this context refers to a logistics provider who is not part of a formal logistics organization (e.g. a transportation company, an alliance of affiliated transportation companies, etc.) and who wishes to take on a transport assignment on an ad-hoc basis. For example, an external logistics provider (ELP) can be an owner and/or an operator (e.g. driver) of one or more vehicles, which can be a truck, a car, a van, some other land vehicle, a boat, a ship, some other waterborne vehicle, an airplane, a helicopter, some other flying vehicle, or the like. A transport assignment includes transportation of one or more parcels from one point (a pick-up location) to another point (a drop-off location). The pick-up location can be a warehouse, production center, a distribution center, a customer location, or the like, or can be a location of another vehicle that needs to transfer one or more parcels to the ELP vehicle (e.g. due to a mechanical, electrical, or other problem; a regulation, illness, or other factor preventing an operator of the other operator from continuing transportation of the one or more parcels; a change in mode of transport such as land to air, truck to rail, land to water, etc.; or the like) to continue an existing transport assignment. The drop-off location can be a customer delivery location, a shipping or distribution center, or the like, or can be a location of another vehicle to which the one or more parcels are to be transferred for further transportation. Because the external logistics provider handles one or more transportation aspects relating to one or more parcels while not being part of the formal logistics organization, the external logistics provider requires some additional authentication, potentially at both pick-up and drop-off of the one or more parcels that are included in the transport assignment.

In comparison to the existing members of a formal logistics organization, which typically have long time trustful customer relationships, external logistics providers do not have this trust per se. Improved approaches are needed to establish the trust between business customers and these external logistics providers, for example to support an ELP in authenticating and authorizing himself or herself in an end-to-end fashion from the pick-up to the drop-off of every delivery with as little manual effort as possible. In addition, the time from the first contact between the trusted logistics network and the external logistics provider until initiation of a transport assignment is desirably reduced to the smallest amount possible (i.e. ad-hoc).

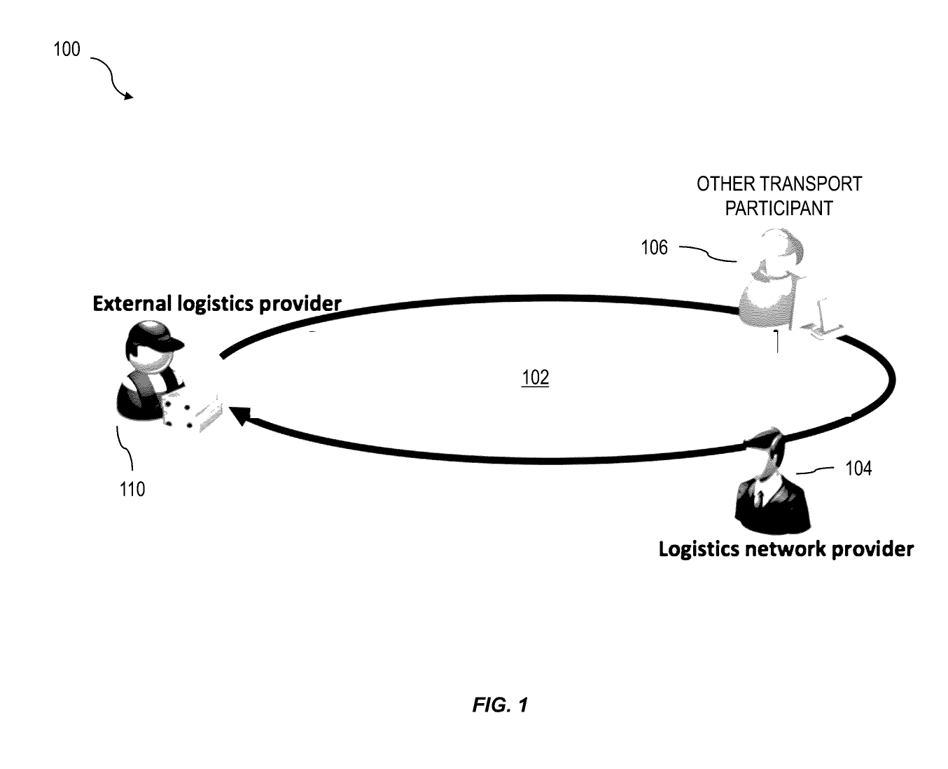

Currently available approaches generally do not satisfy these criteria. FIG. 1 shows a diagram illustrating some of the challenges present in establishing and operating an ad-hoc logistics network. Of specific concern in such an approach is the question of whether the network 102, which in this example includes a logistics network provider 104 and a customer or other transport participant 106 (also referred to herein as an other participant), can trust the external logistics provider operator 110. Key concerns associated with this question can include into in compliance, identification, authentication, and quality of service. The other transport participant 106 can need to be able to trust an external logistics provider and also to have ne able to rely on a specific quality of service. Currently available approaches generally suffer from issues such as significant manual efforts required for on boarding, a lack of automated identification, and a reliance on authentication through visual inspection (e.g. presence of visible identification such as a logo of the logistics company on a uniform or other clothing worn by a delivery worker).

Implementations of the current subject matter can provide a mobile solution for external logistics providers that eases the on-boarding process (initially entering the network) as well as identification at a customer or other transport participant site (e.g. a pick-up and/or drop-off location for transported cargo). Certain advantages can be realized through use of various implementations, which can, for example, allow for online compliance checking during the on-boarding process, enable authorization and authentication at the customer or other transport participant site, and set-up a trust-enabled mobile ad-hoc logistics network.

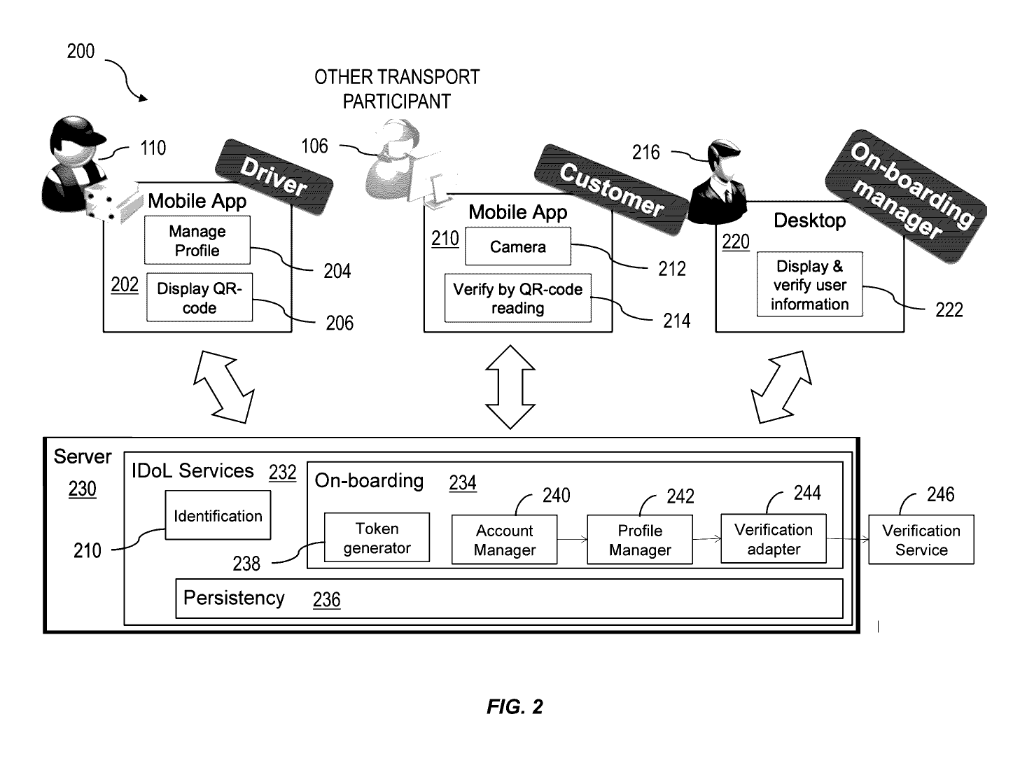

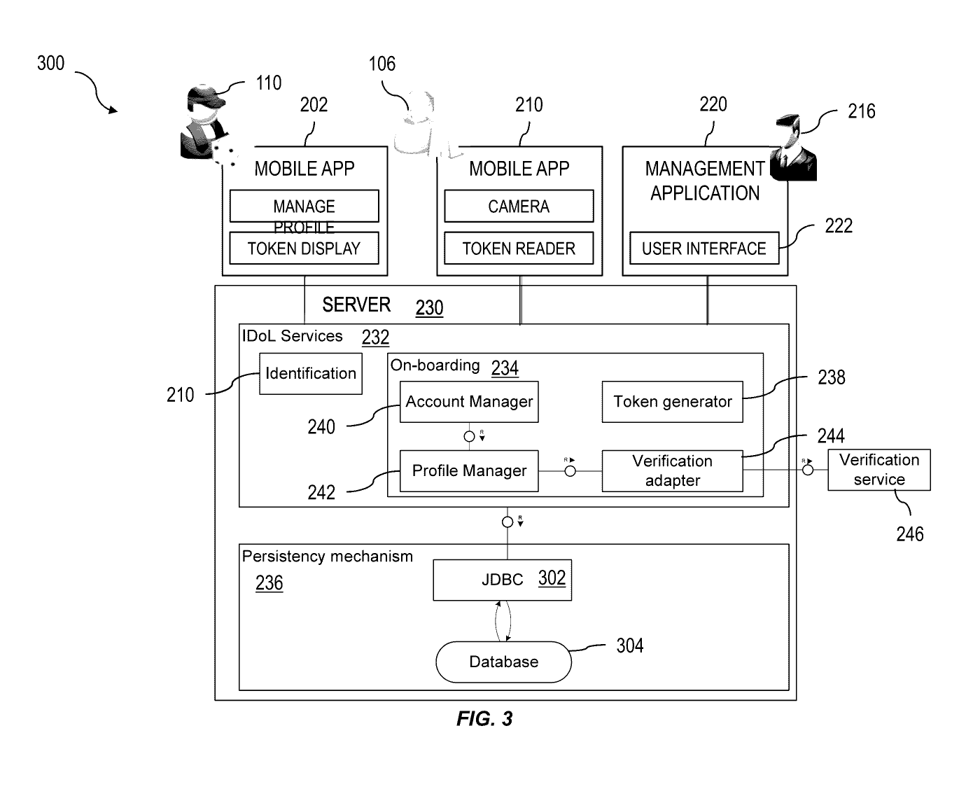

FIG. 2 and FIG. 3 show diagram views 200, 300 illustrating features of a computing architecture capable of providing features described herein. FIG. 2 shows a logical view 200 and FIG. 3 shows a more technical view 300. An external logistics provider operator (e.g. a driver) 110 can use a mobile device to access a backend server. The mobile device can execute a mobile app 202, which can run natively on the mobile device, as a Web application (e.g. executing in a browser on the mobile device), or via other programming approaches with comparable functionality. The mobile app 202 can include user interface functionality 204 for managing an ELP profile and user interface functionality 206 for displaying a verification token, both of which are described in more detail below.

A customer 106, or alternatively another member of the logistics network, can use different functionality of the mobile app, or alternatively a second mobile app 210. This second mobile app 210 can include access to a camera 212 of a mobile device (or optionally a camera providing images to a computer (e.g. a laptop computer, a desktop computer, a tablet computer, etc.), and user interface functionality 214 for capturing and verifying the verification token, when the user interface functionality 206 for displaying the verification token is employed on the mobile app 202 of the ELP operator 110. The “customer” 106 can be interchanged with another member of the LN (which can be either an in-network logistics provider, a second ELP, or any other transport participant), for example when the transport assignment involves a pick-up or drop-off to another transport provider vehicle or location.

A manager 216 (or other authorized decision maker) of the LN can use a LN management application 220, which can include a native application or a Web application running on any kind of computing device (e.g. a desktop, a laptop, a smart phone, a tablet computer, or the like). The management application 220 can include user interface functionality 222 for displaying and verifying user information. As noted above, it will be understood that the mobile app 202, the second mobile app 210, and the management application 220 can be separate software applications with functionality specific to a given type of user (e.g. ELP 110, other transport participant 106 or other transport provider, or manager 216). Alternatively, a single application (e.g. a Web application capable of running on mobile devices and/or other computing devices) can provide all of the noted functionality such that different types of users can access relevant features according to their specific roles. For the remainder of this discussion, the term “mobile app” refers to a combined application with specific features for specific user roles.

All of the mobile app 202, the second mobile app 210, and the computer-implemented on-boarding functionality 220 can all communicate (e.g. over networked connections, which can be wired, wireless, or a combination thereof) with a server 230. The server 230 can be a discrete set of one or more dedicated machines, or alternatively, it can be implemented as a cloud server. The server 230 can support multiple Idol services 232, including identification 232 and on-boarding 234 and can also include a persistency 236. The on-boarding service 234 can include a token generator module 238, an account manager module 240, a profile manager module 242, and a verification adapter 244, which can communicate with a verification service 246, which can optionally be implemented external to the server 230.

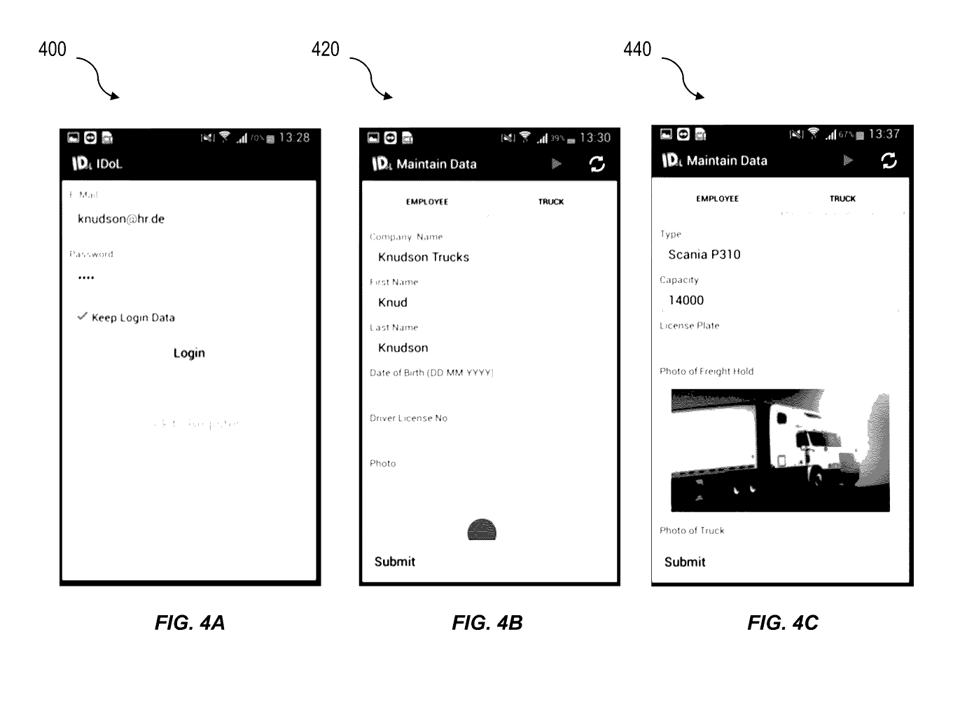

An external logistics provider can register himself or herself or one or more ELP operators/drivers who work for him or her at the trusted logistics network, which can be operated either by a single company or by a set of companies. The external logistics provider can become registered as an ELP operator or driver (terms that are used interchangeably herein) or can register multiple ELP operators (e.g. of a external logistics provider company) through the mobile app via which he or she can enter one more properties of the operator (e.g. name, photo, contact details, driver license, insurance information, driving record, etc.), and one or more properties of the operated vehicle (e.g. brand, type, license plate, photos ensuring the □suitability of the vehicle, etc.).□ FIG. 4A shows a view 400 of a user interface of the mobile app via which the ELP operator can log in and become authenticated to the trusted logistics network. FIG. 4B and FIG. 4C respectively show views 420, 440 of a user interface of the mobile app via which the ELP operator 110 can enter operator properties (e.g. as discussed above) and vehicle properties (also as discussed above).

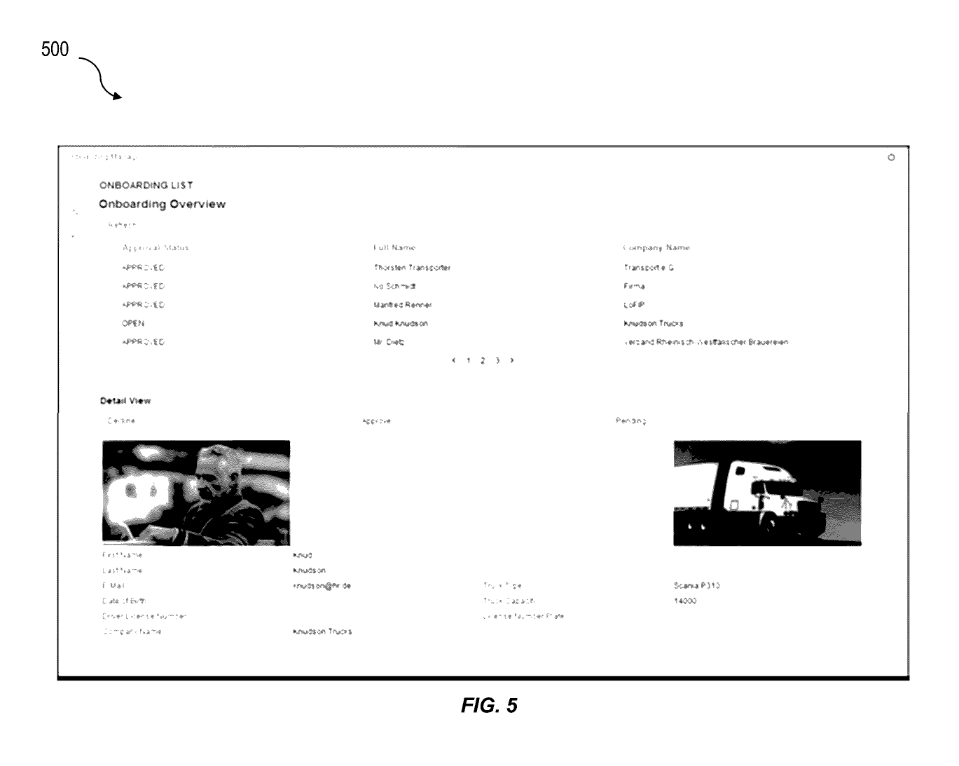

A network manager or other authorized user of the trusted logistics network receives the operator and vehicle properties data, for example via a user interface such as that shown in the view 500 of FIG. 5. The network manager can review the ELP operator and vehicle property data in comparison to criteria specified for registered logistics providers at the trusted logistics network. Based on the submitted ELP operator and vehicle properties data, the network manager decides if the ELP operator 110 may join the network. To verify the data, the network manager may access external services. Examples of such external services are passport verification, driver license verification, credit rating, etc.

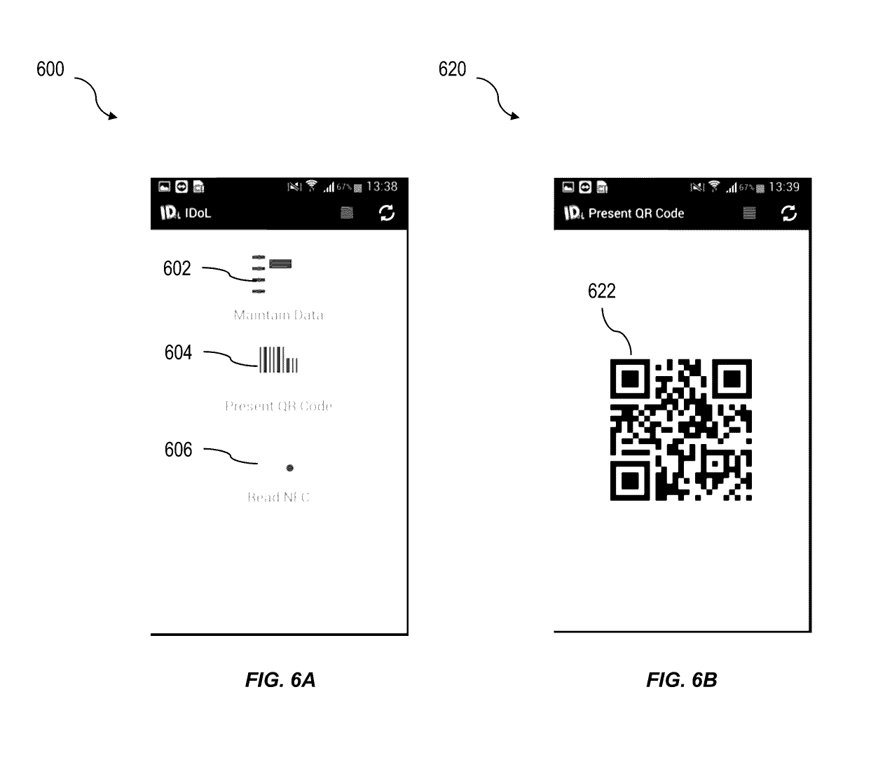

When the network manager approves a registration request, the ELP operator 110 receives an authentication token via the mobile app on his or her mobile device as shown in the views 600, 620 of FIG. 6A and FIG. 6B. In FIG. 6A, the mobile app shows options that allow the ELP operator to maintain his or her properties data 602 (e.g. driver properties and/or vehicle properties), to present an authentication token 604, and/or to activate a near field communication of an authentication token 606. In some examples, an authentication token can include a Quick Response (QR) code, a bar code, some other visible encoded token, a near field communications code, or the like. FIG. 6B shows an example of a QR code 622 consistent with implementations of the current subject matter.

Another participant in a transport assignment can validate the authentication token using other features of the mobile app as discussed below. The other transport participant 106 can be a customer, other member of the logistics organization, or even another ELP operator. A customer can be involved as either or both of the sender and recipient of the one or more parcels of a transport assignment. The other transportation participant can be a sender or recipient of the one or more parcels, such as for example a shipping or distribution center worker, another vehicle operator, a business owner or employee, etc. The authentication token can be specific to a given transportation assignment, and can be required to be shown at either or both of the pick-up and drop-off locations for a transport assignment.

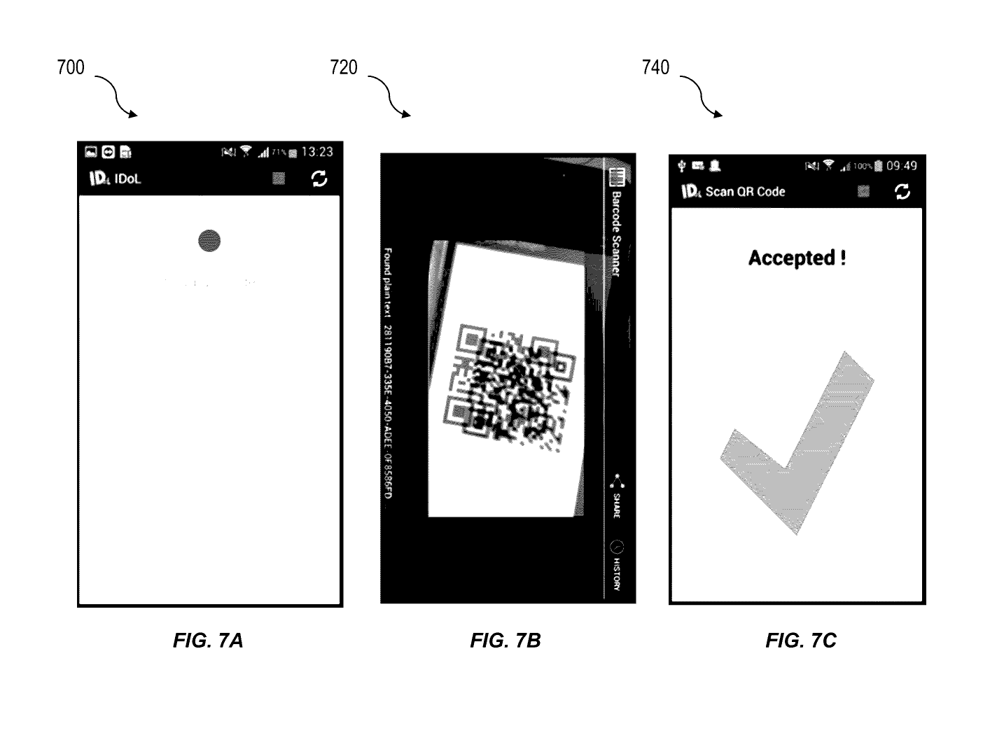

Through use of additional features of the mobile app operating on a device of the other transport participant, the other transport participant can ensure that the ELP operator is part of the trusted logistics network even thought the other participant may have never met or even seen the ELP operator prior to encountering him or her at the pick-up or drop-off location. Based on this authentication, the ELP operator can conduct the authorized transport assignment as though he or she were a trusted partner of the logistics organization. □FIG. 7A shows a view 700 of the mobile app via which the other transport participant can initiate a scan of a QR code (or other visible authentication token). In other implementations of the current subject matter, the mobile app features used by the other transport participant can include activation of a near field communication capability of the mobile device to receive the authentication token from the ELP operator. FIG. 7B shows a view 720 in which the other transport participant's mobile device uses its camera to capture the authentication token (in the example a QR code) displayed on the mobile device of the ELP operator. FIG. 7C shows a view 740 illustrating display to the other transport participant on his or her mobile device that the authentication token has been verified by the trusted logistics network to thereby confirm authorization of the other transport participant to release the one or more parcels of the transport assignment to the ELP operator 110 or to accept the one or more parcels of the transport assignment from the ELP operator 110.

As noted above, to allow authorization for a particular transport assignment, the external logistics provider receives the valid authorization token for that transport assignment. This authorization token authenticates and authorizes the ELP operator 110 to pick up and drop off the one or more parcels of the transport assignment. The authorization token is always logically linked to a specific transport assignment and thereby only valid for the duration of that transport assignment. Whenever the ELP operator 110 picks-up or delivers a parcel other transport participant 106, the ELP operator 110 can show this token. The other transport participant 106 also uses the app and scans the QR code. The captured token is validated by the server 230. If the scanned token is successfully verified the parcel or parcel can be handed over.

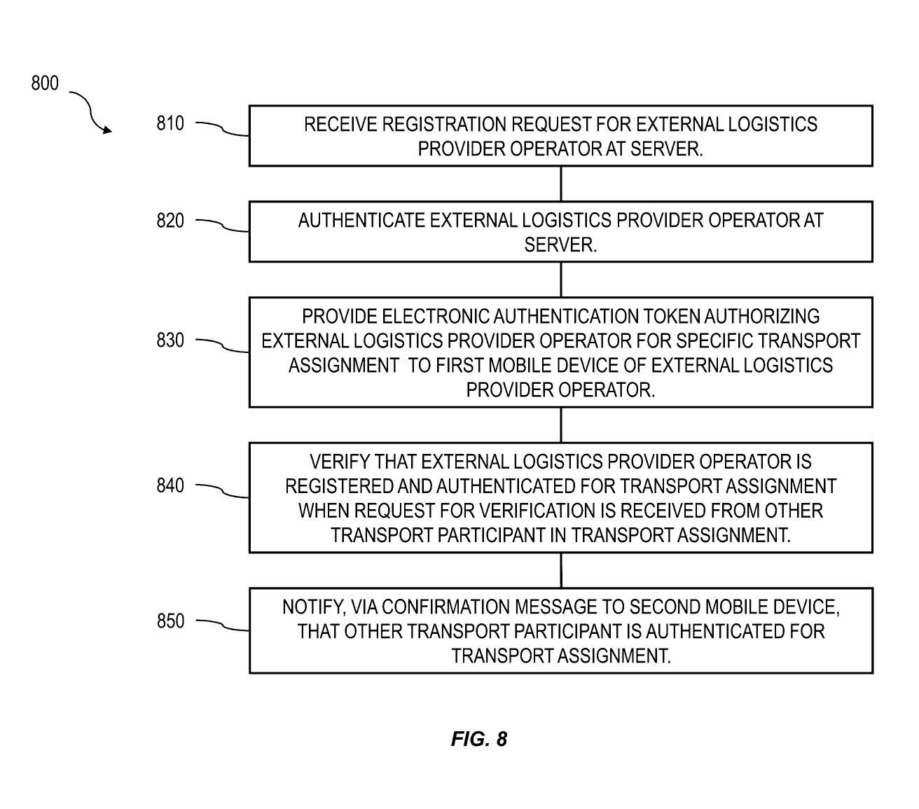

FIG. 8 shows a process flow chart 800 illustrating features of a method consistent with implementations of the current subject matter. At 810, a server implemented on one or more computing machines receives a registration request for an external logistics provider operator, and at 820 the server authenticates the external logistics provider operator. At 830, the server provides an electronic authentication token to a first mobile device of the external logistics provider operator. The electronic authentication token authorizes the external logistics provider operator for a transport assignment. When a request for verification is received from another transport participant in the transport assignment, at 840 the server verifies that the external logistics provider operator is registered and authenticated for the transport assignment. The request for verification includes receipt at the server from a second mobile device of the other transport participant of the electronic authentication token that has been exchanged from the first mobile device to the second mobile device. At 850, the server notifies, via a confirmation message to the second mobile device, that the external logistics provider operator is authenticated for the transport assignment.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a non-transitory machine-readable medium storing instructions that, when executed by at least one programmable processor, cause the at least one programmable processor to perform operations comprising:
providing an electronic authentication token from a server implemented on one or more computing machines to a first mobile device of an external logistics provider operator, the electronic authentication token authorizing the external logistics provider operator for a transport assignment;
verifying, when a request for verification is received from an other transport participant in the transport assignment, that the external logistics provider operator is registered and authenticated for the transport assignment, the request for verification comprising receipt at the server from a second mobile device of the other transport participant of the electronic authentication token that has been exchanged from the first mobile device to the second mobile device; and
notifying, via a confirmation message to the second mobile device, that the external logistics provider operator is authenticated for the transport assignment.

2. A computer program product as in claim 1, wherein the operations further comprise:
receiving a registration request for the external logistics provider operator at the server; and
authenticating the external logistics provider operator at the server.

3. A computer program product as in claim 1, wherein the electronic authentication token comprises one or more of a quick response code, a bar code, and a near field communications code.

4. A computer program product as in claim 1, wherein the request for verification is received from the other transport participant in the transport assignment after the second mobile device captures the electronic authentication token displayed on the first mobile device.

5. A computer program product as in claim 1, wherein the electronic authorization token is logically linked to the transport assignment and only valid for a duration of the transport assignment.

6. A computer program product as in claim 5, wherein the operations further comprise: providing a second electronic authentication token from the server to the first mobile device of the external logistics provider operator, the second electronic authentication token authorizing the external logistics provider operator for a second transport assignment.

7. A system comprising:
computer hardware configured to perform operations comprising:
providing an electronic authentication token from a server implemented on one or more computing machines to a first mobile device of an external logistics provider operator, the electronic authentication token authorizing the external logistics provider operator for a transport assignment;
verifying, when a request for verification is received from an other transport participant in the transport assignment, that the external logistics provider operator is registered and authenticated for the transport assignment, the request for verification comprising receipt at the server from a second mobile device of the other transport participant of the electronic authentication token that has been exchanged from the first mobile device to the second mobile device; and
notifying, via a confirmation message to the second mobile device, that the external logistics provider operator is authenticated for the transport assignment.

8. A system as in claim 7, wherein the operations further comprise:
receiving a registration request for the external logistics provider operator at the server; and
authenticating the external logistics provider operator at the server.

9. A system as in claim 7, wherein the electronic authentication token comprises one or more of a quick response code, a bar code, and a near field communications code.

10. A system as in claim 7, wherein the request for verification is received from the other transport participant in the transport assignment after the second mobile device captures the electronic authentication token displayed on the first mobile device.

11. A system as in claim 7, wherein the electronic authorization token is logically linked to the transport assignment and only valid for a duration of the transport assignment.

12. A system as in claim 11, wherein the operations further comprise: providing a second electronic authentication token from the server to the first mobile device of the external logistics provider operator, the second electronic authentication token authorizing the external logistics provider operator for a second transport assignment.

13. A computer-implemented method comprising:
providing an electronic authentication token from a server implemented on one or more computing machines to a first mobile device of an external logistics provider operator, the electronic authentication token authorizing the external logistics provider operator for a transport assignment;
verifying, when a request for verification is received from an other transport participant in the transport assignment, that the external logistics provider operator is registered and authenticated for the transport assignment, the request for verification comprising receipt at the server from a second mobile device of the other transport participant of the electronic authentication token that has been exchanged from the first mobile device to the second mobile device; and
notifying, via a confirmation message to the second mobile device, that the external logistics provider operator is authenticated for the transport assignment.

14. A computer-implemented method as in claim 13, wherein the operations further comprise:
receiving a registration request for the external logistics provider operator at the server; and
authenticating the external logistics provider operator at the server.

15. A computer-implemented method as in claim 13, wherein the electronic authentication token comprises one or more of a quick response code, a bar code, and a near field communications code.

16. A computer-implemented method as in claim 13, wherein the request for verification is received from the other transport participant in the transport assignment after the second mobile device captures the electronic authentication token displayed on the first mobile device.

17. A computer-implemented method as in claim 13, wherein the electronic authorization token is logically linked to the transport assignment and only valid for a duration of the transport assignment.

18. A computer-implemented method as in claim 17, wherein the operations further comprise: providing a second electronic authentication token from the server to the first mobile device of the external logistics provider operator, the second electronic authentication token authorizing the external logistics provider operator for a second transport assignment.
